(19) United States
(12) Patent Application Publication
(10) Pub. No.: US 2023/0394391 A1
(43) Pub. Date: Dec. 7, 2023

(54) IDENTIFYING SKILL ADJACENCIES AND SKILL GAPS FOR GENERATING RESKILLING RECOMMENDATIONS AND EXPLAINABILITY

(71) Applicant: INTERNATIONAL BUSINESS MACHINES CORPORATION, ARMONK, NY (US)

(72) Inventors: Saksham Gandhi, New York, NY (US); Raj Nagesh, NEW HILL, NC (US); Subhro Das, Cambridge, MA (US)

(21) Appl. No.: 17/805,711

(22) Filed: Jun. 7, 2022

(51) Int. Cl. G06Q 10/06

(52) U.S. Cl. CPC G06Q 10/063112

(57) ABSTRACT

An embodiment for identifying skill adjacencies and skill gaps to generate reskilling recommendations. The embodiment may receive input from a user including candidate details and a job description. The embodiment may automatically extract a first set of skill keywords from the candidate description and a second set of skill keywords from the job description. The embodiment may automatically input the first and second set of skill keywords into a first type of word embedding model and a second type of word embedding model to automatically generate word embeddings. The embodiment may automatically compare the generated word embeddings and calculate cosine similarity scores for the first and second set of skill keywords. The embodiment may automatically identify skill overlaps and skill gaps using the calculated similarity scores, and automatically generating and outputting corresponding explainability statements to the user, and generate and output corresponding reskilling recommendations for the identified skill gaps.

### BACKGROUND

The present application relates generally to identifying skill adjacencies, and more particularly, to identifying skill adjacencies and skill gaps to generate reskilling recommendations by using multiple word embedding models.

Today's fast changing workplace frequently necessitates reskilling of the workforce across a variety of industries and workplace settings. A growing number of jobs require specialized skillsets including constantly changing and expanding definitions of new and evolving skill sets. An automated method to determine skill adjacencies and skill gaps for efficiently reskilling workers is therefore desirable.

### SUMMARY

According to one embodiment, a method, computer system, and computer program product for identifying skill adjacencies and skill gaps to generate reskilling recommendations by using multiple word embedding models is provided. The embodiment may include receiving input from a user including candidate details and a job description. The embodiment may also include automatically extracting a first set of skill keywords from the candidate description and a second set of skill keywords from the job description, and separating the first and second set of skill keywords. The embodiment may also include automatically inputting the first and second set of skill keywords into a first type of word embedding model and a second type of word embedding model to automatically generate word embeddings corresponding to the first and second set of skill keywords. The embodiment may further include automatically comparing the generated word embeddings and calculating cosine similarity scores for the first and second set of skill keywords. The embodiment may also include automatically identify skill overlaps and skill gaps using the calculated similarity scores, and automatically generating and outputting corresponding explainability statements to the user. The embodiment may also include automatically generating and outputting reskilling recommendations to the user based on the identified skill gaps.

### BRIEF DESCRIPTION OF THE SEVERAL VIEWS OF THE DRAWINGS

These and other objects, features and advantages of the present disclosure will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment;

FIG. 2 illustrates an operational flowchart for identifying skill adjacencies and skill gaps to generate reskilling recommendations according to at least one embodiment;

FIG. 3 depicts an illustrative example of inputs and outputs used for generating skill keyword comparisons and skill gap explainability according to at least one embodiment;

FIG. 4 is a functional block diagram of internal and external components of computers and servers depicted in FIG. 1 according to at least one embodiment;

FIG. 5 depicts a cloud computing environment according to an embodiment of the present invention; and

FIG. 6 depicts abstraction model layers according to an embodiment of the present invention.

### DETAILED DESCRIPTION

Detailed embodiments of the claimed structures and methods are disclosed herein; however, it can be understood that the disclosed embodiments are merely illustrative of the claimed structures and methods that may be embodied in various forms. The present disclosure may, however, be embodied in many different forms and should not be construed as limited to the exemplary embodiments set forth herein. In the description, details of well-known features and techniques may be omitted to avoid unnecessarily obscuring the presented embodiments.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

Embodiments of the present application relate generally to identifying skill adjacencies, and more particularly, to identifying skill adjacencies and skill gaps to generate reskilling recommendations by using multiple word embedding models. The following described exemplary embodiments provide a system, method, and program product to, among other things, receive input from a user including candidate details and a job description automatically extract a first set of skill keywords from the candidate description and a second set of skill keywords from the job description, automatically input the first and second set of skill keywords into a first type of word embedding model, and a second type of word embedding model to automatically generate word embeddings corresponding to the first and second set of skill keywords, and automatically compare the generated word embeddings to calculate cosine similarity scores for the first and second set of skill keywords to identify skill overlaps and skill gaps for generating and outputting explainability statements and reskilling recommendations to the user. Therefore, the present embodiment has the capacity to improve approaches to reskilling that require manual labor by providing an automated system for identifying skill adjacencies and skill gaps to generate reskilling recommendations. The present embodiment further improves approaches to reskilling by providing a system that utilizes multiple word embedding models to more accurately generate vectors and calculate similarity scores for extracted sets of skill keywords. The present embodiment further improves approaches to reskilling by providing a system that automatically provides explainability statements and reskilling recommendations to the user based on the calculated similarity scores.

As previously described, today's fast changing workplace frequently necessitates reskilling of the workforce across a variety of industries and workplace settings. A growing number of jobs require specialized skillsets including constantly changing and expanding definitions of new and evolving skill sets. Current approaches to reskilling depend on manual logic, which can be time-consuming and expensive due to their dependence on manual labor requiring an expert to explicitly define relationships between skills. Manual approaches require constant updating of underlying manually-defined skill relationships to accommodate new skills for a given workplace. Manual approaches may be too expensive and therefore inaccessible to non-profit organizations or smaller corporations. Current approaches to reskilling typically do not provide sufficient explainability or remedial actions that may be taken to address an identified skill gap between a potential employee and a given job, preventing candidates from being able to reskill as fast as possible to get back into the staffing pool in a competitive and growing job market. Illustrative embodiments described herein, provide for an improved automated system that more accurately identifies skill adjacencies and skill gaps by using multiple word embedding models, and ultimately generates and outputs reskilling recommendations to a user, thereby providing a more accurate, cheaper approach to reskilling that provides a user with reskilling recommendations and explainability to assist the user in reskilling quickly.

According to at least one embodiment of a computer system capable of employing methods in accordance with the present invention to identify skill adjacencies and skill gaps to generate reskilling recommendations, the method, system, computer program product may receive input from a user including candidate details and a job description. The method, system, computer program product may then automatically extract a first set of skill keywords from the candidate description and a second set of skill keywords from the job description, and separate the first and second set of skill keywords. Next, the method, system, computer program product may automatically input the first and second set of skill keywords into a first type of word embedding model, and a second type of word embedding model to automatically generate word embeddings corresponding to the first and second set of skill keywords. According to one embodiment, the method, system, computer program product may then automatically compare the generated word embeddings and calculate cosine similarity scores for the first and second set of skill keywords. Next, the method, system, computer program product may automatically identify skill overlaps and skill gaps using the calculated similarity scores, and automatically generate and outputting corresponding explainability statements to the user. The method, system, computer program product may then automatically generate and output reskilling recommendations to the user based on the identified skill gaps. In turn, the method, system, computer program product has provided an improved automated system that more accurately identifies skill adjacencies and skill gaps by using multiple word embedding models, and ultimately generates and outputs reskilling recommendations to the user.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may include copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present disclosure are described herein with reference to flowchart illustrations and/or block diagrams of methods, apparatus (systems), and computer program products according to embodiments of the present disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein includes an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which includes one or more executable instructions for implementing the specified logical function(s). In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following described exemplary embodiments provide a system, method, and program product for identifying skill adjacencies and skill gaps to generate reskilling recommendations.

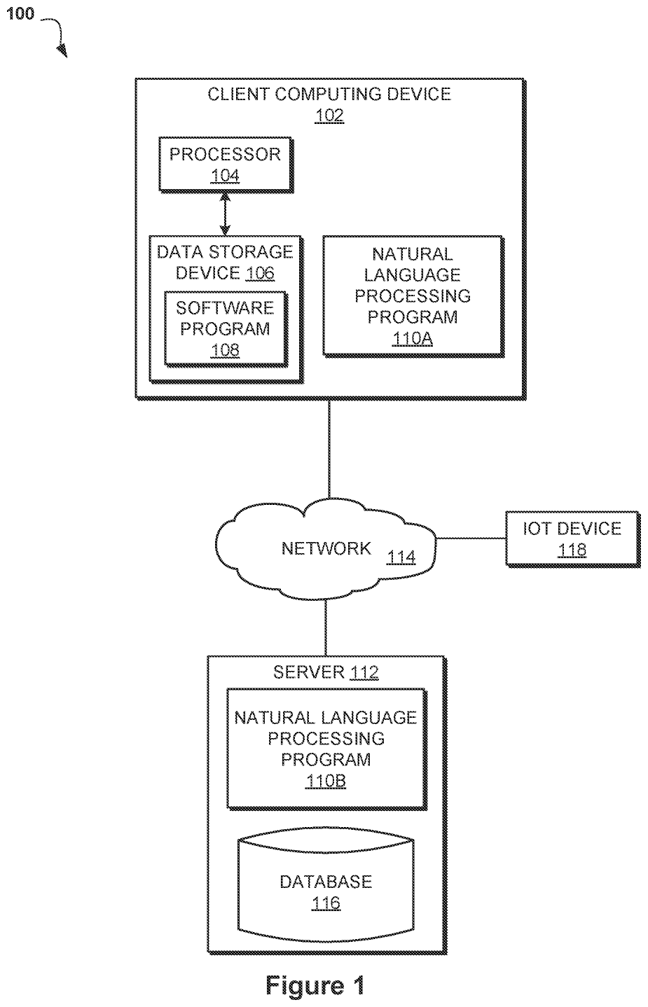

Referring to FIG. 1, an exemplary networked computer environment 100 is depicted, according to at least one embodiment. The networked computer environment 100 may include client computing device 102, a server 112, and Internet of Things (IoT) Device 118 interconnected via a communication network 114. According to at least one implementation, the networked computer environment 100 may include a plurality of client computing devices 102 and servers 112, of which only one of each is shown for illustrative brevity.

The communication network 114 may include various types of communication networks, such as a wide area network (WAN), local area network (LAN), a telecommunication network, a wireless network, a public switched network and/or a satellite network. The communication network 114 may include connections, such as wire, wireless communication links, or fiber optic cables. It may be appreciated that FIG. 1 provides only an illustration of one implementation and does not imply any limitations with regard to the environments in which different embodiments may be implemented. Many modifications to the depicted environments may be made based on design and implementation requirements.

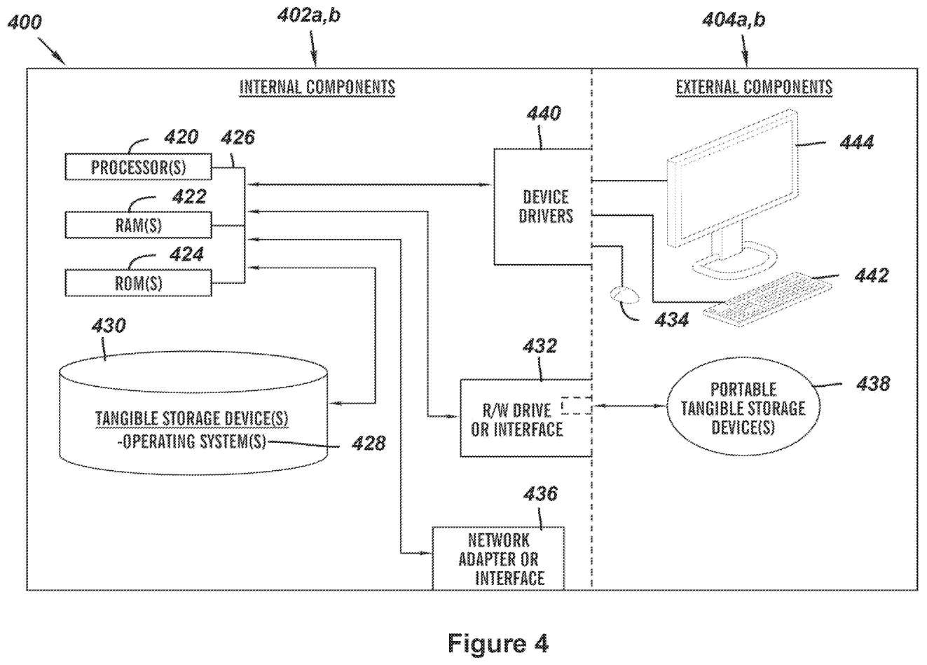

Client computing device 102 may include a processor 104 and a data storage device 106 that is enabled to host and run a software program 108 and a reskilling recommendation program 110A and communicate with the server 112 and IoT Device 118 via the communication network 114, in accordance with one embodiment of the present disclosure. Client computing device 102 may be, for example, a mobile device, a telephone, a personal digital assistant, a netbook, a laptop computer, a tablet computer, a desktop computer, or any type of computing device capable of running a program and accessing a network. As will be discussed with reference to FIG. 4, the client computing device 102 may include internal components 402a and external components 404a, respectively.

The server computer 112 may be a laptop computer, netbook computer, personal computer (PC), a desktop computer, or any programmable electronic device or any network of programmable electronic devices capable of hosting and running a reskilling recommendation program 110B and a database 116 and communicating with the client computing device 102 and IoT Device 118 via the communication network 114, in accordance with embodiments of the present disclosure. As will be discussed with reference to FIG. 4, the server computer 112 may include internal components 402b and external components 404b, respectively. The server 112 may also operate in a cloud computing service model, such as Software as a Service (SaaS), Platform as a Service (PaaS), or Infrastructure as a Service (IaaS). The server 112 may also be located in a cloud computing deployment model, such as a private cloud, community cloud, public cloud, or hybrid cloud.

IoT Device 118 may be a mobile device, a voice-controlled personal assistant, and/or any other IoT Device 118 known in the art for receiving queries that is capable of connecting to the communication network 114, and transmitting and receiving data with the client computing device 102 and the server 112.

According to the present embodiment, the reskilling recommendation program 110A,110B may be a program capable of receiving input from a user including candidate details and a job description. Reskilling recommendation program 110A,110B may then automatically extract a first set of skill keywords from the candidate description and a second set of skill keywords from the job description and separate the first and second set of skill keywords. Next, reskilling recommendation program 110A,110B may then automatically input the first and second set of skill keywords into a first type of word embedding model and a second type of word embedding model to automatically generate word embeddings corresponding to the first and second set of skill keywords. Reskilling recommendation program 110A,110B may then automatically compare the generated word embeddings and calculate cosine similarity scores for the first and second set of skill keywords. Next, reskilling recommendation program 110A,110B may then automatically identify skill overlaps and skill gaps using the calculated similarity scores, and automatically generating and outputting corresponding explainability statements to the user. Finally, reskilling recommendation program 110A,110B may automatically generate and output reskilling recommendations to the user based on the identified skill gaps. In turn, reskilling recommendation program 110A,110B has provided for an improved automated system that more accurately identifies skill adjacencies and skill by using multiple word embedding models, and ultimately generates and outputs reskilling recommendations to a user, thereby providing a more accurate, cheaper approach to reskilling that provides a user with reskilling recommendations and explainability to assist the user in reskilling quickly.

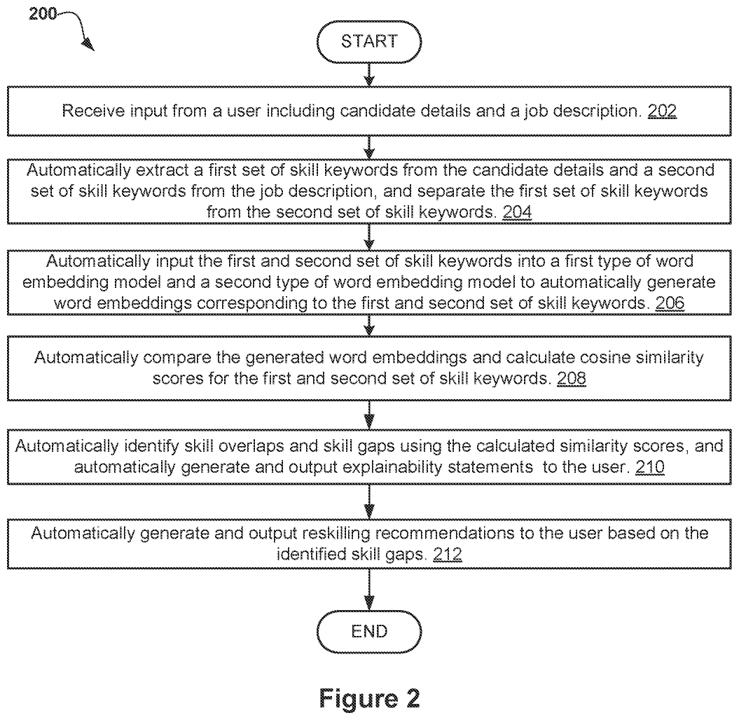

Referring now to FIG. 2, an operational flowchart depicting a process 200 for identifying skill adjacencies and skill gaps to generate reskilling recommendations according to at least one embodiment is provided. At 202, the reskilling recommendation program 110A,110B receives input from a user including candidate details and a job description. Candidate details may include a variety of data for a given candidate in need of reskilling or restaffing. For example, candidate details may include a resume, job role, skill specialty, historical certifications, and employee ID. In instances where a resume is deemed insufficient, the additional information sources listed above may be sourced from an organization's HR system. The job description may include a written description of the selected job, or a description of a given project, role, or desired specialty. Job description data may also be sourced from an organization's HR system or other stored talent acquisition data. In one illustrative example, reskilling recommendation program 110A,110B may receive an input from a user including candidate details for a Candidate A, and a job description for a Job B that is related to a job opening for a software engineer.

At 204, the reskilling recommendation program 110A,110B automatically extracts a first set of skill keywords from the candidate details and a second set of skill keywords from the job description, and separates the first and second set of skill keywords. In other words, reskilling recommendation program 110A,110B will separate skill keywords from the candidate details and the job description into two separate groups. For example, reskilling recommendation program 110A,110B may extract a first set of skill keywords from the candidate details for an exemplary Candidate A including the following skill keywords: ‘Neural_networks’, ‘nlp’, ‘excel’, ‘machine_learning’, and ‘c++’ and sort this first set of skill keywords into a first group. Reskilling recommendation program 110A,110B may then extract a second set of skill keywords from the job description for an exemplary Job B including the following skill keywords: ‘python’, ‘machine_learning’, ‘communication’, and ‘consulting’ and sort this second set of skill keywords into a second group. Reskilling recommendation program 110A,110B may include a variety of skills-related datasets to function as a skills corpus or dictionary of relevant technical and non-technical skills. These skill-related datasets may be obtained through available job listings or through analysis of external job markets that are domain-specific or generalized. An exemplary skills corpus may be further enhanced with skills, tools, and technology related keywords sourced from a third-party website that includes a large number of job postings and candidate details therein. Once a skills corpus is established, skill keywords may be extracted from free text (resumes, job descriptions). Keyword extraction may be performed with any suitable extraction module, such as, for example, flashtext python library's KeywordProcessor module with case sensitivity, to extract keywords from text.

Next, at 206, reskilling recommendation program 110A,110B automatically inputs the first and second set of skill keywords into a first type of word embedding model, and a second type of word embedding model to automatically generate word embeddings corresponding to the first and second set of skill keywords.

In an exemplary described embodiment, the first type of word embedding model may be a Word2Vec model. The Word2Vec model may be custom-trained on the skills corpus discussed above. For the training of the Word2Vec model, the chosen parameters may include skipgram vs CB OW, hierarchical softmax vs negative sampling, embedding size, and evaluation method. In embodiments, the skipgram method is considered, negative sampling is considered, the embedding size may be 100, and the window size may be 5. Python library gensim's Word2Vec implementation may be used to train the model on the selected datasets, and then the genism python module's skip-gram technique may be used to generate the word embeddings. The corpus may be passed through a data cleaning pipeline to tokenize the keywords to ensure effective training. Once the Word2Vec model training is completed, the trained model file may be saved so that vectors can be loaded later for leveraging word embeddings in computing cosine similarity scores for skill keywords calculated at 208, described in more detail below.

The second word embedding model may be a DistilBERT model. The DistilBERT model may be used to produce dense skill keyword vector representations. A vector representation for a single skill keyword may be obtained by feeding a phrase or skill keyword into the DistilBERT model and taking the mean of the subword token vectors the model produces. In embodiments, the DistilBERT model may include further pretraining on a domain specific corpus for a given job description. Entire paragraphs of a given job description may be used for pre-training. Alternatively, skill keywords may be extracted using the methods described above, which then may be used for further pre-training. Once pre-training language is selected, a masked language modelling approach, for example masking 15% of all tokens in the pretraining text, may be used for training. The number of epochs of pre-training may range from 20 to 100 using increments of 20.

The generation of word embeddings for a given set of skill keywords is ultimately used to calculate similarity scores for determining and output reskilling recommendations. As such, the accuracy of the word embeddings for a given set of skill keywords is important. In an exemplary embodiment, the extracted skill keywords may be run through both a Word2Vec model and DistilBERT model. This is because it was determined that each model has its own strengths for generating accurate embeddings for certain types of skill keywords. For example, the DistilBERT model provides more accurate results for non-technical skill keywords that contain no acronyms, as DistilBERT relies on a rich language understanding provided through extensive pre-training. However, for technical skills, skill names may not align with their literal meanings. For example, “Beautiful Soup”, a python web scraping library, has a misalignment between the literal meaning of the words and the meaning of the skill. Accordingly, DistilBERT would generate a less accurate word embedding than the Word2Vec model which relies on co-occurrence frequency of the skills and would therefore be unaffected by the misalignment. There is similar, if not more pronounced, misalignment for skill keywords containing acronyms. Accordingly, illustrative embodiments in accordance with this disclosure run the skill keywords through both models to generate word embeddings with improved accuracy, thereby improving the accuracy of the similarity scores and the generated reskilling recommendations. Accordingly, in embodiments, reskilling recommendation program 110A,110B may be configured to include an ensemble (composite) model including both the Word2Vec and DistilBERT model to best handle a variety of extracted skill keywords. For example, in a describe embodiment, a Word2Vec model and a DistilBERT model may be trained using the same corpus of data. Then, manual annotations of a given list of skill keyword pairs may be made by unbiased volunteers. These manual annotations may be used as a standard against which each model's performance may be evaluated. This allows for determination and validation of which models more accurately characterize which types of skill keyword pairs, ultimately allowing for the use of an ensemble model approach using a composite model containing both the Word2Vec model and the DistilBERT model to process the most appropriate skill keyword pairings. It is envisioned that reskilling recommendation program 110A,110B may be configured to utilize other combinations of word embedding models to form ensemble or composite models using two separate word embedding models to characterize a variety of extracted skill keywords more accurately.

At 208, reskilling recommendation program 110A,110B automatically compares the word embeddings generated at 206 and calculates cosine similarity scores for the first and second set of skill keywords. Cosine similarity is a measure of similarity between two non-zero vectors of an inner product space that measures the cosine angle between them. A cosine similarity score of 1.0 indicates that two skill keywords are identical, and a score of 0 indicates no similarity. The closer the calculated cosine similarity score is to 1.0, the more similar the skill keywords being compared are, and the more likely there is a skill overlap. The lower the calculated cosine score is, the more likely there is a skill gap.

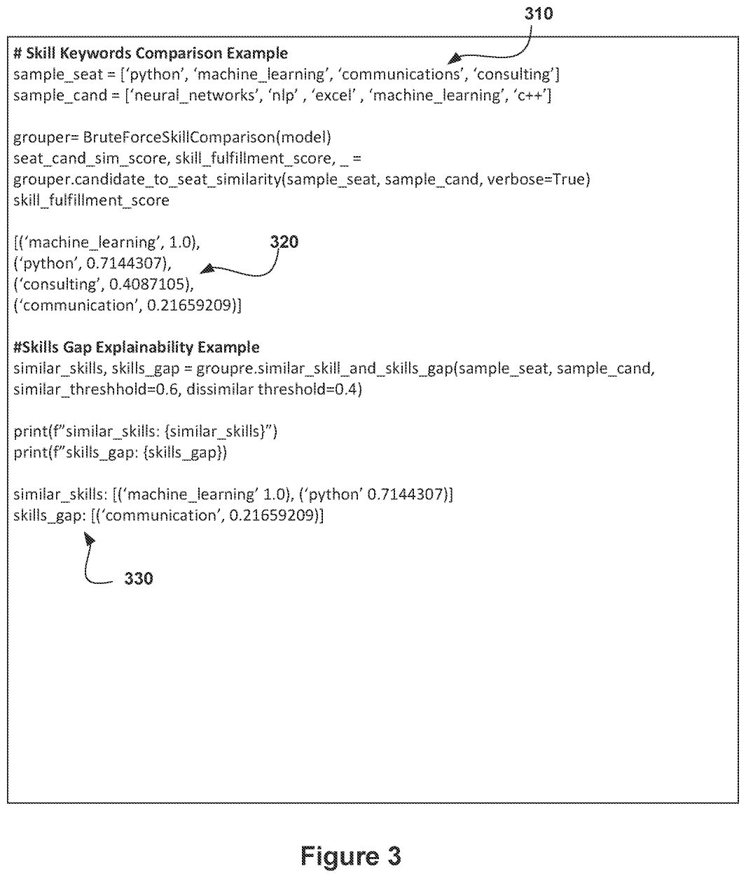

Referring now to FIG. 3, using the same example discussed above depicting an example process 300, reskilling recommendation program 110A,110B may, for example, extract ‘Neural_networks’, ‘nlp’, ‘excel’, ‘machine_learning’, and ‘c++’ as skill keywords 310 from Candidate A, and ‘python’, ‘machine_learning’, ‘communication’, and ‘consulting’ as keywords from Job Description B. Then reskilling recommendation program 110A,110B may use the word embeddings generated at 206 for these illustrative sets of skill keywords to calculate cosine similarity scores 320 for each of the skill keywords. For example, reskilling recommendation program 110A,110B may calculate and output the following similarity scores: [(‘machine_learning’, 1.0), (‘python’, 0.7144307), (‘consulting’, 0.4087105), (communication’, 0.2165209)]. In this example, reskilling recommendation program 110A,110B calculated a cosine similarity score of 1.0 for the skill keyword ‘machine_learning’ because there was an exact match of skill keywords in the candidate details, and the job description. Reskilling recommendation program 110A,110B then calculated a cosine similarity score of 0.7144307 for ‘Python’ because although the candidate details did not explicitly include ‘Python’, reskilling recommendation program 110A,110B valued the remaining skill keywords in the candidate details as being similar enough to generate a similarity score between 0.5 and 1.0. Lastly, reskilling recommendation program 110A,110B calculated a similarity score for ‘communication’ of 0.2165209 because the skill keywords in the candidate details were not determined to be similar to the skill keywords from the job description.

Next, at 210, reskilling recommendation program 110A,110B automatically identifies skill overlaps and skill gaps using the calculated cosine similarity scores, and automatically generates and output explainability statements to the user. A user may define a suitable skill satisfaction threshold that reskilling recommendation program 110A,110B may be configured to recognize. If a skill keyword in the job description has a corresponding vector embedding that has a cosine similarity score (calculated at 208) to the candidate detail skill keyword vector that is higher than the skill satisfaction threshold, then this skill keyword would be identified as being associated with a skill overlap. The remaining skill keywords that fall below the skill satisfaction threshold would be identified as being associated with skill gaps. Next, reskilling recommendation program 110A,110B may automatically generate and output explainability statements 330 to the user identifying which skill keywords were categorized as similar skills, and which were identified as skill gaps. For example, using the same example as above, reskilling recommendation program 110A,110B may generate and output the following (as illustrated in FIG. 3) to a user if using a threshold of 0.6: “similar_skills: [(‘machinelearning’, 1.0), (‘python’, 0.7144307)] Skills_gap: [(‘communicaiton’, 0.21659209)]”

Finally, at 212, reskilling recommendation program 110A,110B automatically generates and outputs reskilling recommendations to the user based on identified skill gaps. In embodiments, the reskilling recommendations may include, for example, recommended courses, assignments, or alternative open jobs. In the above example, reskilling recommendation program 110A,110B would generate and output a reskilling recommendation to the user for ‘communications’ because it was identified as a skill keyword that was associated with a skill gap. Thus, reskilling recommendation program 110A,110B may output to the user the name of a training course or program for addressing the identified skill gap. In another example in which the skill gap was for the skill keyword “Python”, reskilling recommendation program may, for example, output to the user a recommendation including “Introduction to Python Programming” or “Advanced Concepts in Python Programming” or other courses for which the “python” skill keyword is a core skill. In embodiments, reskilling recommendations may be domain-specific, and added to reskilling recommendation program 110A,110B via manual annotations. In embodiments, reskilling recommendation program 110A,110B may use a machine learning approach to recommend reskilling plans based on the identified skill gaps.

In the context of this disclosure, machine learning broadly describes a function of a system that learns from data. Machine learning is a branch of artificial intelligence that relates to mathematical models that can learn from, categorize, and make predictions about data. Such mathematical models, which can be referred to as machine-learning models, can classify input data among two or more classes; cluster input data among two or more groups; predict a result based on input data; identify patterns or trends in input data; identify a distribution of input data in a space; or any combination of these. Examples of machine-learning models can include (i) neural networks; (ii) decision trees, such as classification trees and regression trees; (iii) classifiers, such as Naïve bias classifiers, logistic regression classifiers, ridge regression classifiers, random forest classifiers, least absolute shrinkage and selector (LASSO) classifiers, and support vector machines; (iv) clusterers, such as k-means clusterers, mean-shift clusterers, and spectral clusterers; (v) factorizers, such as factorization machines, principal component analyzers and kernel principal component analyzers; and (vi) ensembles or other combinations of machine-learning models. In some examples, neural networks can include deep neural networks, feed-forward neural networks, recurrent neural networks, convolutional neural networks, radial basis function (RBF) neural networks, echo state neural networks, long short-term memory neural networks, bi-directional recurrent neural networks, gated neural networks, hierarchical recurrent neural networks, stochastic neural networks, modular neural networks, spiking neural networks, dynamic neural networks, cascading neural networks, neuro-fuzzy neural networks, or any combination of these.

Machine-learning models can be constructed through an at least partially automated (e.g., with little or no human involvement) process called training. During training, input data can be iteratively supplied to a machine-learning model to enable the machine-learning model to identify patterns related to the input data or to identify relationships between the input data and output data. With training, the machine-learning model can be transformed from an untrained state to a trained state. Input data can be split into one or more training sets and one or more validation sets, and the training process may be repeated multiple times. The splitting may follow a k-fold cross-validation rule, a leave-one-out-rule, a leave-p-out rule, or a holdout rule.

It may be appreciated that FIGS. 2 and 3 provide only illustrations of an exemplary implementation and do not imply any limitations with regard to how different embodiments may be implemented. Many modifications to the depicted environments may be made based on design and implementation requirements.

FIG. 4 is a block diagram 400 of internal and external components of the client computing device 102 and the server 112 depicted in FIG. 1 in accordance with an embodiment of the present disclosure. It should be appreciated that FIG. 4 provides only an illustration of one implementation and does not imply any limitations with regard to the environments in which different embodiments may be implemented. Many modifications to the depicted environments may be made based on design and implementation requirements.

The data processing system 402, 404 is representative of any electronic device capable of executing machine-readable program instructions. The data processing system 402, 404 may be representative of a smart phone, a computer system, PDA, or other electronic devices. Examples of computing systems, environments, and/or configurations that may represented by the data processing system 402, 404 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

The client computing device 102 and the server 112 may include respective sets of internal components 402 a,b and external components 404 a,b illustrated in FIG. 4. Each of the sets of internal components 402 include one or more processors 420, one or more computer-readable RAMs 422, and one or more computer-readable ROMs 424 on one or more buses 426, and one or more operating systems 428 and one or more computer-readable tangible storage devices 430. The one or more operating systems 428, the software program 108 and the reskilling recommendation program 110A in the client computing device 102 and the reskilling recommendation program 110B in the server 112 are stored on one or more of the respective computer-readable tangible storage devices 430 for execution by one or more of the respective processors 420 via one or more of the respective RAMs 422 (which typically include cache memory). In the embodiment illustrated in FIG. 4, each of the computer-readable tangible storage devices 430 is a magnetic disk storage device of an internal hard drive. Alternatively, each of the computer-readable tangible storage devices 430 is a semiconductor storage device such as ROM 424, EPROM, flash memory or any other computer-readable tangible storage device that can store a computer program and digital information.

Each set of internal components 402 a,b also includes a RAY drive or interface 432 to read from and write to one or more portable computer-readable tangible storage devices 438 such as a CD-ROM, DVD, memory stick, magnetic tape, magnetic disk, optical disk or semiconductor storage device. A software program, such as the reskilling recommendation program 110A, 110B, can be stored on one or more of the respective portable computer-readable tangible storage devices 438, read via the respective R/W drive or interface 432, and loaded into the respective hard drive 430.

Each set of internal components 402 a,b also includes network adapters or interfaces 436 such as a TCP/IP adapter cards, wireless Wi-Fi interface cards, or 3G or 4G wireless interface cards or other wired or wireless communication links. The software program 108 and the reskilling recommendation program 110A in the client computing device 102 and the reskilling recommendation program 110B in the server 112 can be downloaded to the client computing device 102 and the server 112 from an external computer via a network (for example, the Internet, a local area network or other, wide area network) and respective network adapters or interfaces 436. From the network adapters or interfaces 436, the software program 108 and the reskilling recommendation program 110A in the client computing device 102 and the reskilling recommendation program 110B in the server 112 are loaded into the respective hard drive 430. The network may comprise copper wires, optical fibers, wireless transmission, routers, firewalls, switches, gateway computers and/or edge servers.

Each of the sets of external components 404 a,b can include a computer display monitor 444, a keyboard 442, and a computer mouse 434. External components 404 a,b can also include touch screens, virtual keyboards, touch pads, pointing devices, and other human interface devices. Each of the sets of internal components 402 a,b also includes device drivers 440 to interface to computer display monitor 444, keyboard 442, and computer mouse 434. The device drivers 440, R/W drive or interface 432, and network adapter or interface 436 include hardware and software (stored in storage device 430 and/or ROM 424).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

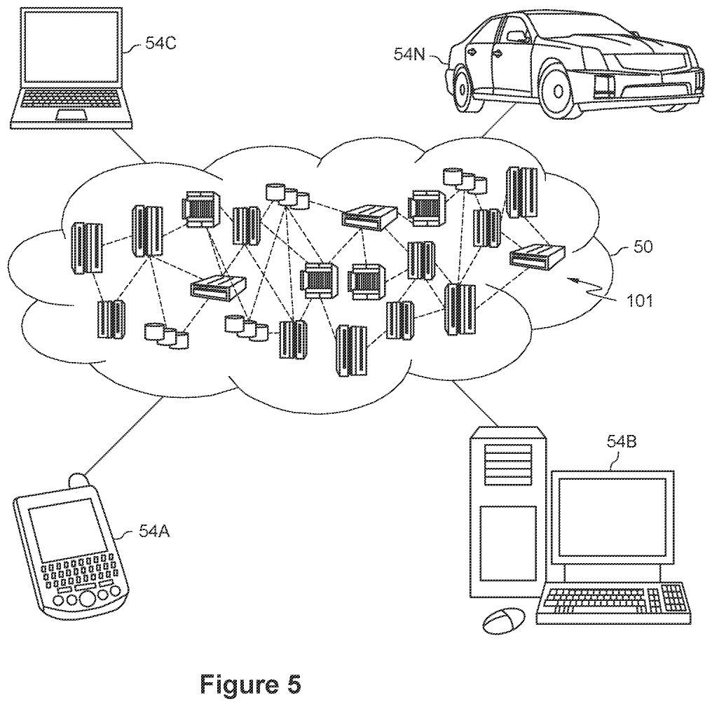

Referring now to FIG. 5, illustrative cloud computing environment 50 is depicted. As shown, cloud computing environment 50 includes one or more cloud computing nodes 101 with which local computing devices used by cloud consumers, such as, for example, personal digital assistant (PDA) or cellular telephone 54A, desktop computer 54B, laptop computer 54C, and/or automobile computer system 54N may communicate. Nodes 101 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 5 are intended to be illustrative only and that computing nodes 100 and cloud computing environment 50 can communicate with any type of computerized device over any type of network and/or network addressable connection (e.g., using a web browser).

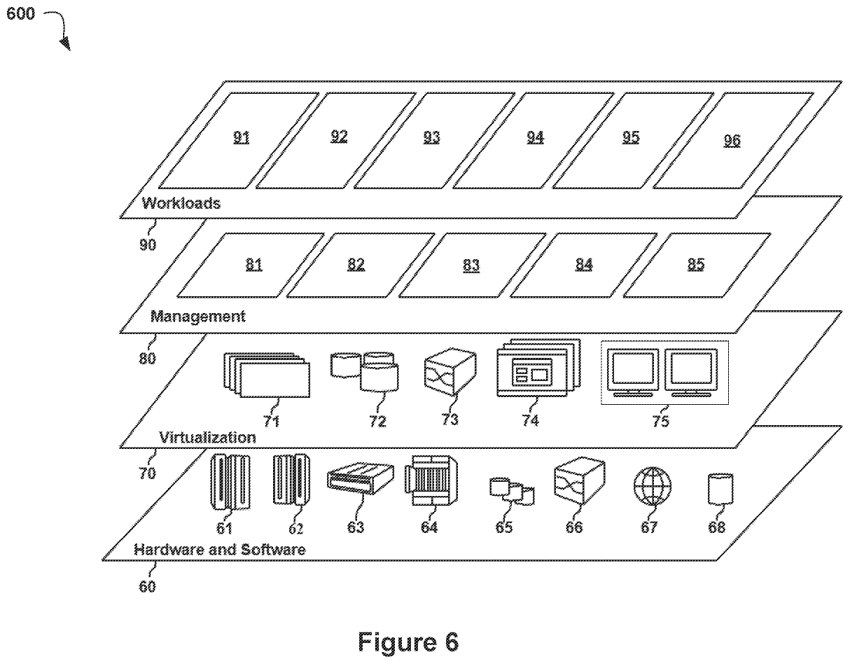

Referring now to FIG. 6, a set of functional abstraction layers 600 provided by cloud computing environment 50 is shown. It should be understood in advance that the components, layers, and functions shown in FIG. 6 are intended to be illustrative only and embodiments of the present disclosure are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; reskilling recommendations 96. Reskilling recommendations 96 may relate to automatically identifying skill adjacencies and skill gaps to generate reskilling recommendations using multiple word embedding models.

The descriptions of the various embodiments of the present invention have been presented for purposes of illustration but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-based method of identifying skill adjacencies and skill gaps to generate reskilling recommendations, the method comprising:
receiving input from a user including candidate details and a job description;
automatically extracting a first set of skill keywords from the candidate description and a second set of skill keywords from the job description, and separating the first and second set of skill keywords;
automatically inputting the first and second set of skill keywords into a first type of word embedding model and a second type of word embedding model to automatically generate word embeddings corresponding to the first and second set of skill keywords;
automatically comparing the generated word embeddings and calculating cosine similarity scores for the first and second set of skill keywords;
automatically identifying skill overlaps and skill gaps using the calculated similarity scores, and automatically generating and outputting corresponding explainability statements to the user; and
automatically generating and outputting reskilling recommendations to the user based on the identified skill gaps.

2. The computer-based method of claim 1, wherein automatically extracting the first set of skill keywords from the candidate description and the second set of skill keywords from the job description, and separating the first and second set of skill keywords further comprises:
comparing the input from the user to a skills corpus comprising a list of relevant technical and non-technical skills sourced from one or more of domain specific job listings, analysis of external job markets, and third party websites.

3. The computer-based method of claim 1, wherein the candidate details comprise at least one of a resume, a job role, a skill specialty, historical certifications, and an employee ID.

4. The computer-based method of claim 1, wherein the first type of word embedding model is a Word2Vec model and the second type of word embedding model is a DistilBERT model.

5. The computer-based method of claim 1, wherein automatically inputting the first and second set of skill keywords into the first type of word embedding model and the second type of word embedding model to automatically generate word embeddings corresponding to the first and second set of skill keywords further comprises:
using the skip-gram technique to generate the word embeddings.

6. The computer-based method of claim 1, wherein automatically identifying the skill overlaps and the skill gaps using the calculated similarity scores, and automatically generating and outputting corresponding explainability statements to the user further comprises:
comparing the calculated similarity scores to a pre-determined similarity score threshold.

7. The computer-based method of claim 1, a machine learning model is utilized to automatically generate and output the reskilling recommendations to the user based on the identified skill gaps.

8. A computer system, the computer system comprising:
one or more processors, one or more computer-readable memories, one or more computer-readable tangible storage medium, and program instructions stored on at least one of the one or more computer-readable tangible storage medium for execution by at least one of the one or more processors via at least one of the one or more computer-readable memories, wherein the computer system is capable of performing a method comprising:
receiving input from a user including candidate details and a job description;
automatically extracting a first set of skill keywords from the candidate description and a second set of skill keywords from the job description, and separating the first and second set of skill keywords;
automatically inputting the first and second set of skill keywords into a first type of word embedding model, and a second type of word embedding model to automatically generate word embeddings corresponding to the first and second set of skill keywords;
automatically comparing the generated word embeddings and calculating cosine similarity scores for the first and second set of skill keywords;
automatically identifying skill overlaps and skill gaps using the calculated similarity scores, and automatically generating and outputting corresponding explainability statements to the user; and
automatically generating and outputting reskilling recommendations to the user based on the identified skill gaps.

9. The computer system of claim 8, wherein automatically extracting the first set of skill keywords from the candidate description and the second set of skill keywords from the job description, and separating the first and second set of skill keywords further comprises:
comparing the input from the user to a skills corpus comprising a list of relevant technical and non-technical skills sourced from one or more of domain specific job listings, analysis of external job markets, and third party websites.

10. The computer system of claim 9, wherein the candidate details comprise at least one of a resume, a job role, a skill specialty, historical certifications, and an employee ID.

11. The computer system of claim 8, wherein the first type of word embedding model is a Word2Vec model and the second type of word embedding model is a DistilBERT model.

12. The computer system of claim 8, wherein automatically inputting the first and second set of skill keywords into the first Word2Vec word embedding model, and the second DistilBERT word embedding model to automatically generate word embeddings corresponding to the first and second set of skill keywords further comprises:
using the skip-gram technique to generate the word embeddings.

13. The computer system of claim 8, wherein automatically identifying the skill overlaps and the skill gaps using the calculated similarity scores, and automatically generating and outputting corresponding explainability statements to the user further comprises:
comparing the calculated similarity scores to a pre-determined similarity score threshold.

14. The computer system of claim 8, a machine learning model is utilized to automatically generate and output the reskilling recommendations to the user based on the identified skill gaps.

15. A computer program product, the computer program product comprising:
one or more computer-readable tangible storage medium and program instructions stored on at least one of the one or more computer-readable tangible storage medium, the program instructions executable by a processor capable of performing a method, the method comprising:
receiving input from a user including candidate details and a job description;
automatically extracting a first set of skill keywords from the candidate description and a second set of skill keywords from the job description, and separating the first and second set of skill keywords;
automatically inputting the first and second set of skill keywords into a first type of word embedding model, and a second type of word embedding model to automatically generate word embeddings corresponding to the first and second set of skill keywords;
automatically comparing the generated word embeddings and calculating cosine similarity scores for the first and second set of skill keywords;
automatically identifying skill overlaps and skill gaps using the calculated similarity scores, and automatically generating and outputting corresponding explainability statements to the user; and
automatically generating and outputting reskilling recommendations to the user based on the identified skill gaps.

16. The computer program product of claim 15, wherein automatically extracting the first set of skill keywords from the candidate description and the second set of skill keywords from the job description, and separating the first and second set of skill keywords further comprises:
comparing the input from the user to a skills corpus comprising a list of relevant technical and non-technical skills sourced from one or more of domain specific job listings, analysis of external job markets, and third party websites.

17. The computer program product of claim 16, wherein the candidate details comprise one or more of a resume, a job role, a skill specialty, historical certifications, and an employee ID.

18. The computer program product of claim 15, wherein the first type of word embedding model is a Word2Vec model and the second type of word embedding model is a DistilBERT model.

19. The computer program product of claim 15, wherein automatically inputting the first and second set of skill keywords into the first type of word embedding model and the second type of word embedding model to automatically generate word embeddings corresponding to the first and second set of skill keywords further comprises:
using the skip-gram technique to generate the word embeddings.

20. The computer program product of claim 15, wherein automatically identifying the skill overlaps and the skill gaps using the calculated similarity scores, and automatically generating and outputting corresponding explainability statements to the user further comprises:
comparing the calculated similarity scores to a pre-determined similarity score threshold.
